(19) United States
(12) Patent Application Publication
(10) Pub. No.: US 2016/0071018 A1
(43) Pub. Date: Mar. 10, 2016

(54) METHOD AND SYSTEM FOR SOLVING AN OPTIMIZATION PROBLEM INVOLVING GRAPH SIMILARITY

(71) Applicant: 1QB INFORMATION TECHNOLOGIES INC., Vancouver (CA)

(72) Inventors: MARITZA HERNANDEZ, Burnaby (CA); ARMAN ZARIBAFIYAN, Vancouver (CA)

(21) Appl. No.: 14/838,162

(22) Filed: Aug. 27, 2015

Related U.S. Application Data
(60) Provisional application No. 62/048,244, filed on Sep. 9, 2014.

(51) Int. Cl. G06N 7/00; G06F 17/30

(52) U.S. Cl. CPC G06N 7/00; G06F 17/30958; G06F 17/30598

(57) ABSTRACT

A method and system are disclosed for solving an optimization problem involving graph similarity in more than one graph using a binary optimizer, the method comprising obtaining, in a digital computer, an optimization problem involving graph similarity; generating, using the digital computer, at least one binary optimization problem representative of the optimization problem; providing the generated at least one binary optimization problem to a binary optimizer in an analog computer; the digital computer obtaining from a binary optimizer binary solutions generated by solving the at least one binary optimization problem using the binary optimizer; and the digital computer providing an indication of a maximum common subgraph in the more than one graph using the generated binary solutions.

### CROSS-REFERENCE TO RELATED APPLICATION

The present patent application claims priority on U.S. Provisional Patent Application No. 62/048,244, filed on Sep. 9, 2014.

### FIELD

The invention relates to graph similarity. More precisely, the invention pertains to a method and system for solving an optimization problem involving graph similarity.

### BACKGROUND

Graphs are powerful mathematical objects which can be used to describe or model different real world objects in a rigorous mathematical fashion, (e.g., graphs can represent a social network, stock market, call graphs, chemical graphs, etc.).

A graph consists of a set of vertices and a set of edges between those vertices. In general, both vertices and edges in a graph can have multiple attributes like label, weight, direction, etc.

Graph representations have many applications in machine learning or artificial intelligence algorithms. Many of these algorithms use comparisons of graph representations of the problem.

An extensive overview and survey on graphs, graph similarities, and their applications can be found in Computational Challenges with Cliques, Quasi-cliques and Clique Partitions in Graphs by Panos M. Pardalos and Steffen Rebennack, Experimental Algorithms, Lecture Notes in Computer Science Volume 6049, 2010, pp 13-22. And Networks: And Introduction by Mark Newman, Oxford University Press, March 2010.

Various features of both graph representation (e.g., the definition of vertices, edges and their labels, etc.) and graph similarity (e.g., the specific criteria under which two objects are considered to be similar and/or dissimilar) are general concepts that can be selected accordingly for the specific application one is approaching. The performance of the algorithm depends heavily on a proper selection of such features.

Features of the invention will be apparent from review of the disclosure, drawings and description of the invention below.

### BRIEF SUMMARY

In accordance with a broad aspect, there is disclosed a method for solving an optimization problem involving graph similarity in more than one graph using a binary optimizer, the method comprising obtaining, in a digital computer, an optimization problem involving graph similarity; generating, using the digital computer, at least one binary optimization problem representative of the optimization problem; providing the generated at least one binary optimization problem to a binary optimizer in an analog computer; solving the at least one binary optimization problem using the binary optimizer to generate binary solutions; the digital computer receiving the generated binary solutions from the binary optimizer and the digital computer providing an indication of a maximum common subgraph in the more than one graph using the generated binary solutions.

In accordance with an embodiment, the optimization problem involves graph similarity in a plurality of graphs and the method further comprises iteratively executing in the digital computer a classifier with the indication of a maximum common subgraph of at least one pair of graphs to determine a best classifier and the digital computer providing an indication of the best classifier.

In accordance with an embodiment, the at least one optimization problem is obtained from at least one of a user, a computer, a software package and an agent.

In accordance with an embodiment, the indication of the best classification is provided by the digital computer to at least one of a user, a memory of said digital computer and another computer operatively connected to the digital computer.

In accordance with another broad aspect, there is disclosed a method for solving an optimization problem involving graph similarity in more than one graph using a binary optimizer, the method comprising obtaining, in a digital computer, an optimization problem involving graph similarity; generating, using the digital computer, at least one binary optimization problem representative of the optimization problem; providing the generated at least one binary optimization problem to a binary optimizer in an analog computer; the digital computer obtaining from a binary optimizer binary solutions generated by solving the at least one binary optimization problem using the binary optimizer and the digital computer providing an indication of a maximum common subgraph in the more than one graph using the generated binary solutions.

In accordance with an embodiment, the optimization problem involves graph similarity in two graphs and the method further comprises executing in the digital computer a classifier with the indication of a maximum common subgraph to determine a best classification and the digital computer providing an indication of the best classification.

In accordance with an embodiment, the at least one binary optimization problem comprises at least one polynomial in binary variables.

In accordance with another broad aspect, there is disclosed a digital computer comprising a central processing unit; a display device; a communication port for connecting the digital computer to a binary optimizer in an analog computer; a memory unit comprising an application for solving an optimization problem involving graph similarity in more than one graph, the application comprising instructions for obtaining, in the digital computer, an optimization problem involving graph similarity; instructions for generating, using the digital computer, at least one binary optimization problem representative of the optimization problem; instructions for providing the generated at least one binary optimization problem to a binary optimizer in an analog computer; instructions for obtaining, via the communication port, binary solutions generated by solving the at least one binary optimization problem using the binary optimizer and instructions for providing an indication of a maximum common subgraph in the more than one graph using the generated binary solutions,

In accordance with an embodiment, the optimization problem involves graph similarity in a plurality of graphs and the application further comprises instructions for executing a classifier with the indication of a maximum common subgraph of at least one pair of graphs to determine a best classifier and instructions for providing an indication of the best classifier.

In accordance with a broad aspect, there is disclosed a non-transitory computer-readable storage medium for storing computer-executable instructions which, when executed, cause a digital computer to perform a method for solving an optimization problem involving graph similarity in more than one graph using a binary optimizer, the method comprising obtaining, in the digital computer, an optimization problem involving graph similarity; generating, using the digital computer, at least one binary optimization problem representative of the optimization problem; providing the generated at least one binary optimization problem to a binary optimizer in an analog computer; the digital computer obtaining from a binary optimizer binary solutions generated by solving the at least one binary optimization problem using the binary optimizer; and the digital computer providing an indication of a maximum common subgraph in the more than one graph using the generated binary solutions.

The method disclosed herein enables to efficiently calculate similarity between two graphs and to classify such graphs using a process that takes advantage of a binary optimizer. Specifically, the method comprises obtaining in a digital computer a set of graph objects; applying a graph similarity method and calculating a similarity function for all pairs of graphs using the binary optimizer; and training a classifier based on the similarity function on the digital computer. Specifically, the similarity method comprises of using a microprocessor for receiving a graph, converting the graph to a higher (more than or equal to 2) order binary polynomial representative of the graph and providing the binary polynomial to the analog computer to thereby solve the binary optimization graph similarity problem.

An advantage of a method disclosed herein is that it incorporates solutions of a binary optimizer. in general, the graph similarity method disclosed herein enables the comparison of two or more labeled and weighted graphs providing their maximum common subgraph.

The algorithm can handle any number of graphs with any set of attributes possible as a result of its generalized approach.

Although the proposed graph similarity method can be used to find the common subgraph between multiple graphs, for the purpose of classification, we focus on the pair-wise similarity in the remainder of the patent.

The method disclosed herein makes a prior art digital computer operate more efficiently when the digital computer is used for classifying graphs. This is achieved by advantageously using a binary optimizer.

The method disclosed herein provides the user with the ability to set the above features in order to solve the graph similarity and classification problems. As will be expanded on below, the user will have the ability to override a list of keywords in order to implement various features of the graph similarity method as desired.

Method overriding is a concept in object oriented programming and is allowed in many programming languages such as Python, Java, and C++. Method overriding is a language feature that allows a subclass or child class to provide a specific implementation of a method that is already provided by one of its superclasses or parent classes.

### BRIEF DESCRIPTION OF THE DRAWINGS

In order that the invention may be readily understood, embodiments of the invention are illustrated by way of example in the accompanying drawings.

FIG. 1 is a flowchart that shows an embodiment of a method for solving an optimization problem involving graph similarity and graph classification using a binary optimizer.

FIG. 2 is a diagram of an embodiment of a system in which the method for solving an optimization problem using an analog computer may be implemented. The system is comprised of a digital computer and an analog computer.

FIG. 3 is a diagram that shows an embodiment of a digital computer used in the system for solving an optimization problem using an analog computer.

FIG. 4 is a flowchart that shows an embodiment for setting up a graph similarity problem as an optimization problem,

FIG. 5 is a flowchart that shows an embodiment for setting up at least one binary optimization problem.

FIG. 6 is a flowchart that shows an embodiment for implementing usage of a classifier.

Further details of the invention and its advantages will be apparent from the detailed description included below.

### DETAILED DESCRIPTION

In the following description of the embodiments, references to the accompanying drawings are by way of illustration of an example by which the invention may be practiced.

### Terms

The term “invention” and the like mean “the one or more inventions disclosed in this application”, unless expressly specified otherwise.

The terms “an aspect”, “an embodiment”, “embodiment”, “embodiments”, “the embodiment”, “the embodiments”, “one or more embodiments”, “some embodiments”, “certain embodiments”, “one embodiment” “another embodiment” and the like mean “one or more (but not all) embodiments of the disclosed invention(s)”, unless expressly specified otherwise.

A reference to “another embodiment” or “another aspect” in describing an embodiment does not imply that the referenced embodiment is mutually exclusive with another embodiment (e.g., an embodiment described before the referenced embodiment), unless expressly specified otherwise.

The terms “including”, “comprising” and variations thereof mean “including but not limited to”, unless expressly specified otherwise.

The terms “a”, “an” and “the” mean “one or more”, unless expressly specified otherwise.

The term “plurality” means “two or more”, unless expressly specified otherwise.

The term “herein” means “in the present application, including anything which may be incorporated by reference”, unless expressly specified otherwise.

The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim.

The term “e.g.” and like terms mean “for example”, and thus does not limit the term or phrase it explains. For example, in a sentence “the computer sends data (e.g., instructions, a data structure) data the Internet”, the term “e.g.” explains that “instructions” are an example of “data” that the computer may send over the Internet, and also explains that “a data structure” is an example of “data” that the computer may send over the Internet. However, both “instructions” and “a data structure” are merely examples of “data”, and other things besides “instructions” and “a data structure” can be “data”.

The term “i.e.” and like terms mean “that is”, and thus limits the term or phrase it explains. For example, in the sentence “the computer sends data (i.e., instructions) over the Internet”, the term “i.e.” explains that “instructions” are the “data” that the computer sends over the Internet.

The term “optimization problem” and like terms mean finding a minimum of an “objective function” y=f(x) in variable x ∈ D, where D is a real domain (e.g. a metric space, a real vector space, etc. or a subspace of such) under the constraint of x ∈ F, here F ⊂ D is called the “feasible” region.

The feasible region can for instance be determined by a (possibly empty) family of equality constraints, gᵢ(x)=0 for i ∈ 1, . . . , s and a (possibly empty) family of inequality constraints, hⱼ(x)≦bⱼ for j ∈ 1, . . . , r.

The term “binary optimizer” and like terms mean any system consisting of one or many types of hardware that implements optimization of degree two polynomials in binary variables. The variables can for instance be zero/one or plus/minus one, and the degree of the polynomials can be two or higher. An example of a binary optimizer is a machine that simulates/implements quantum annealing can be seen in: Catherine C. McGeoch and Gong Wang (2013), “Experimental evaluation of an adiabatic quantum system for combinatorial optimization” in Proceedings of the ACM International Conference on Computing Frontiers (CF '13). ACM, New York, N.Y., USA, Article 23, 11 pages. DOI: 10.1145/2482767.2482797 (http://doi.acm,org/10.1145/2482767.2482797).

it will be appreciated that the term “binary optimizer” may be comprised of “classical components”, such as a classical digital computer, in one embodiment. Accordingly the “binary optimizer” may entirely be analog or an analog-classical hybrid.

Neither the Title nor the Abstract is to be taken as limiting in any way as the scope of the disclosed invention(s). The title of the present application and headings of sections provided in the present application are for convenience only, and are not to be taken as limiting the disclosure in any way.

Numerous embodiments are described in the present application, and are presented for illustrative purposes only. The described embodiments are not, and are not intended to be, limiting in any sense. The presently disclosed invention(s) are widely applicable to numerous embodiments, as is readily apparent from the disclosure. One of ordinary skills in the art will recognize that the disclosed invention(s) may be practiced with various modifications and alterations, such as structural and logical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

It will be appreciated that the invention may be implemented in numerous ways, including as a method, a system, a computer readable medium such as a computer readable storage medium. In this specification, these implementations, or any other form that the invention may take, may be referred to as systems or techniques. A component such as a processor or a memory described as being configured to perform a task includes both a general component that is temporarily configured to perform the task at a given time or a specific component that is manufactured to perform the task.

With all this in mind, the present invention is directed to a method, system, and computer program product for solving an optimization problem involving graph similarity in more than one graph using a binary optimizer. It will be appreciated that in one embodiment the method for solving the optimization problem involving graph similarity in more than one graph using a binary optimizer may be used for classifying graphs as explained below.

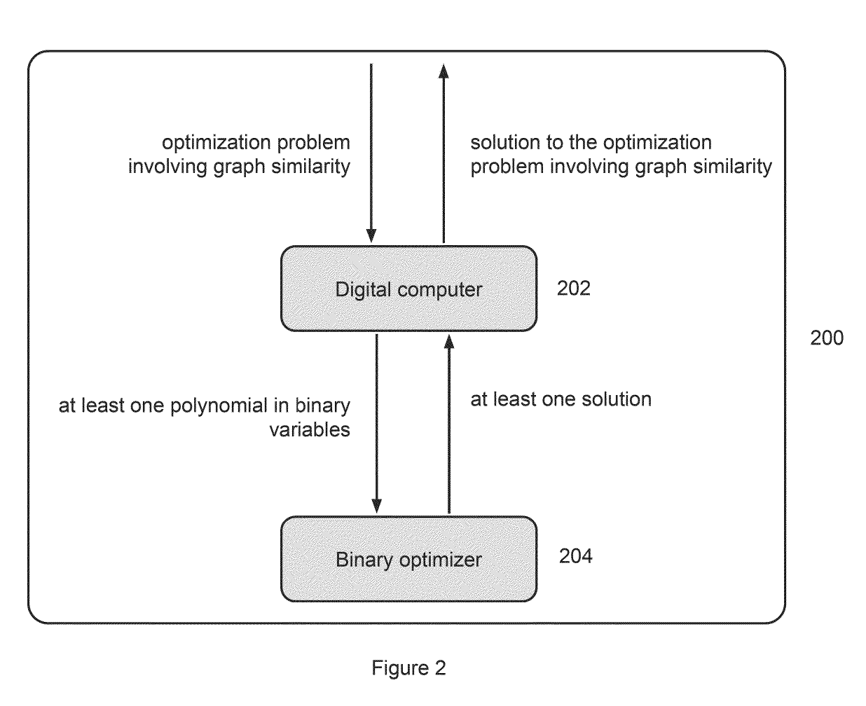

Now referring to FIG. 2, there is shown an embodiment of a system 200 in which an embodiment of a method for solving an optimization problem involving graph similarity.

The system 200 comprises a digital computer 202 and a binary optimizer 204.

The digital computer 202 receives an optimization problem involving graph similarity and provides a solution to the optimization problem. While it is disclosed that the digital computer 202 receives an optimization problem involving graph similarity, it will be appreciated by the skilled addressee that more than one optimization problem involving graph similarity may be received by the digital computer 202.

It will be appreciated that the optimization problem involving graph similarity may be provided according to various embodiments.

In one embodiment, the optimization problem involving graph similarity may be provided by a programmer writing scripts in one of the supported languages (Python/C++/Matlab) interacting with the digital computer 202 and overriding a selection of reserved keywords in the system 200.

In an alternative embodiment, the optimization problem involving graph similarity may be provided by another computer operatively connected to the digital computer 202, not shown. In another alternative embodiment, the optimization problem involving graph similarity may be provided by an independent software package. In a further alternative embodiment, the optimization problem involving graph similarity may be provided by an intelligent agent.

Similarly, it will be appreciated that the solution to the optimization problem involving graph similarity may be provided according to various embodiments.

in accordance with an embodiment, the solution to the optimization problem involving graph similarity is provided to the user interacting with the digital computer 202.

In accordance with an alternative embodiment, the solution to the optimization problem involving graph similarity is provided to another computer operatively connected to the digital computer 202.

in accordance with another alternative embodiment, the solution to the optimization problem involving graph similarity is stored in a memory operatively connected to the digital computer 202.

It will be appreciated by the skilled addressee that the digital computer 202 may be any type of computer.

In one embodiment, the digital computer 202 is selected from a group consisting of desktop computers, laptop computers, tablet PC's, servers, smartphones, etc.

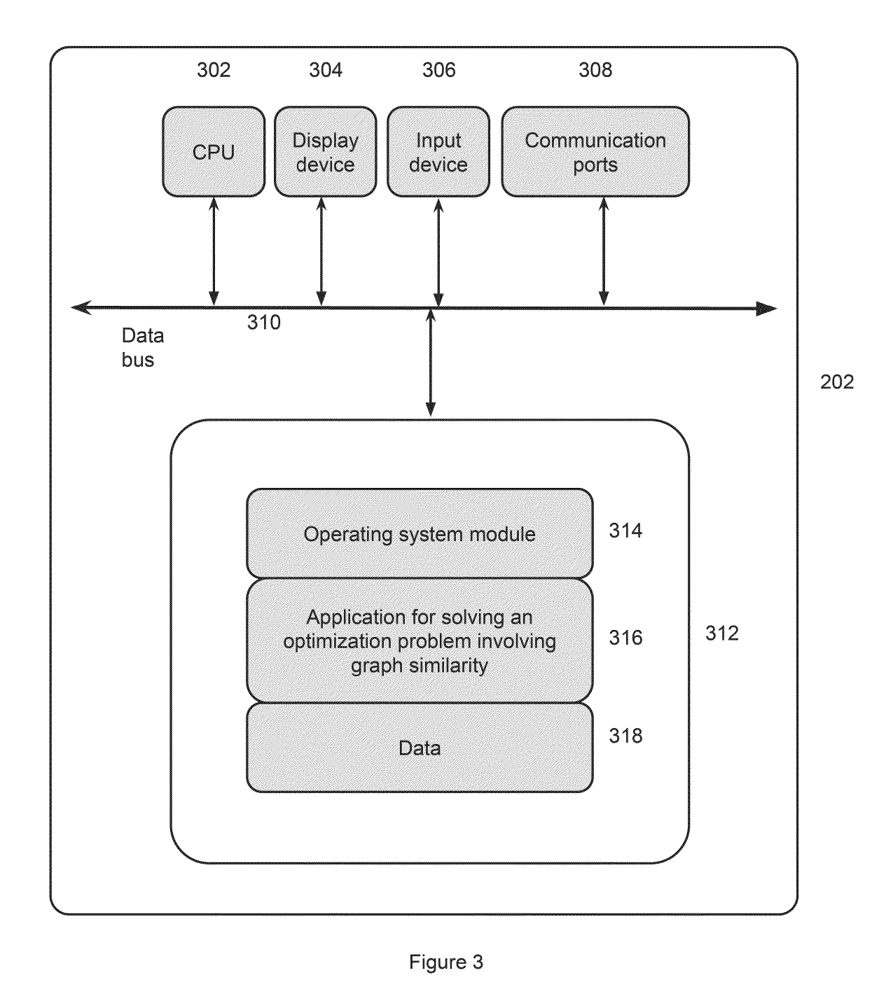

FIG. 3 shows an embodiment of a digital computer 202,

in this embodiment, the digital computer 202 comprises a central processing unit (CPU) 302, also referred to as a microprocessor, a display device 304, input devices 306, communication ports 308, a data bus 310 and a memory unit 312.

The CPU 302 is used for processing computer instructions. The skilled addressee will appreciate that various embodiments of the CPU 302 may be provided.

In one embodiment, the CPU 302 is a CPU Core i7-3820 running at 3.6 GHz and manufactured by Intel™.

The display device 304 is used for displaying data to a user. The skilled addressee will appreciate that various types of display device may be used.

In one embodiment, the display device 304 is a standard liquid-crystal display (LCD) monitor.

The communication ports 308 are used for sharing data with the digital computer 202.

The communication ports 308 may comprise for instance a universal serial bus (USB) port for connecting a keyboard and a mouse to the digital computer 202.

The communication ports 308 may further comprise a data network communication port such as an IEEE 802.3 (Ethernet) port for enabling a connection of the digital computer 202 with another computer via a data network.

The skilled addressee will appreciate that various alternative embodiments of the communication ports 308 may be provided.

In one embodiment, the communication ports 308 comprise an Ethernet port and a mouse port (e.g., Logitech™).

The memory unit 312 is used for storing computer executable instructions.

It will be appreciated that the memory unit 312 comprises in one embodiment an operating system module 314.

It will be appreciated by the skilled addressee that the operating system module 314 may be of various types.

In an embodiment, the operating system module 314 is Windows™ 8 manufactured by Microsoft™.

The memory unit 312 further comprises an application for solving an optimization problem involving graph similarity in more than one graph 316,

The memory unit 312 may further comprise data 318 used by the application for solving an optimization problem involving graph similarity in more than one graph 316.

In one embodiment, the application for solving an optimization problem involving graph similarity in more than one graph 316 comprises instructions for obtaining, in the digital computer, an optimization problem involving graph similarity. The application for solving an optimization problem involving graph similarity in more than one graph 316 further comprises instructions for generating, using the digital computer, at least one binary optimization problem representative of the optimization problem involving graph similarity. The application for solving an optimization problem involving graph similarity in more than one graph 316 further comprises instructions for providing the generated at least one binary optimization problem to a binary optimizer in an analog computer. The application for solving an optimization problem involving graph similarity in more than one graph 316 further comprises instructions for obtaining, via the communication port, binary solutions generated by solving the at least one binary optimization problem using the binary optimizer. The application for solving an optimization problem involving graph similarity in more than one graph 316 further comprises instructions for providing an indication of a maximum common subgraph in the more than one graph using the generated binary solutions, in one embodiment wherein the optimization problem involves graph similarity in a plurality of graphs, the application for solving an optimization problem involving graph similarity in more than one graph 316 further comprises instructions for iteratively executing a classifier with the indication of a maximum common subgraph of at least one pair of graphs to determine a best classification and instructions for providing an indication of the best classification.

it will be also appreciated that there is also disclosed a non-transitory computer-readable storage medium. The non-transitory computer-readable storage medium is used for storing computer-executable instructions which, when executed, cause a digital computer to perform a method for solving an optimization problem involving graph similarity in more than one graph using a binary optimizer, the method comprising obtaining, in the digital computer, an optimization problem involving graph similarity; generating, using the digital computer, at least one binary optimization problem representative of the optimization problem; providing the generated at least one binary optimization problem to a binary optimizer in an analog computer; the digital computer obtaining from a binary optimizer binary solutions generated by solving the at least one binary optimization problem using the binary optimizer; and the digital computer providing an indication of a maximum common subgraph in the more than one graph using the generated binary solutions.

Each of the CPU 302, the display device 304, the input devices 306, the communication ports 308 and the memory unit 312 is interconnected via the data bus 310.

Now referring back to FIG. 2, it will be appreciated that the binary optimizer 204 is operatively connected to the digital computer 202.

It will be appreciated that the coupling of the binary optimizer 204 to the digital computer 202 may be achieved according to various embodiments.

In one embodiment, the coupling of the binary optimizer 204 to the digital computer 202 is achieved via a data network.

The binary optimizer 204 may be of various types.

In one embodiment, the binary optimizer 204 is manufactured by D-Wave Systems Inc. More information on this analog computer 204 can be found at http//www.dwavesys.com/en/dev-tutorial-hardware.html. The skilled addressee will appreciate that various alternative embodiments may be provided for the binary optimizer.

More precisely, the binary optimizer 204 receives at least one binary optimization problem from the digital computer 202. in one embodiment, the at least one binary optimization problem comprises at least one polynomial in binary variables. It will be appreciated that the at least one polynomial in binary variables may be stored in a data structure.

A binary optimizer is capable of advantageously minimizing the at least one polynomial in binary variables and providing at least one corresponding solution.

The at least one solution is provided by the binary optimizer 204 to the digital computer 202. It will be appreciated that the at least one solution may be stored in a data structure.

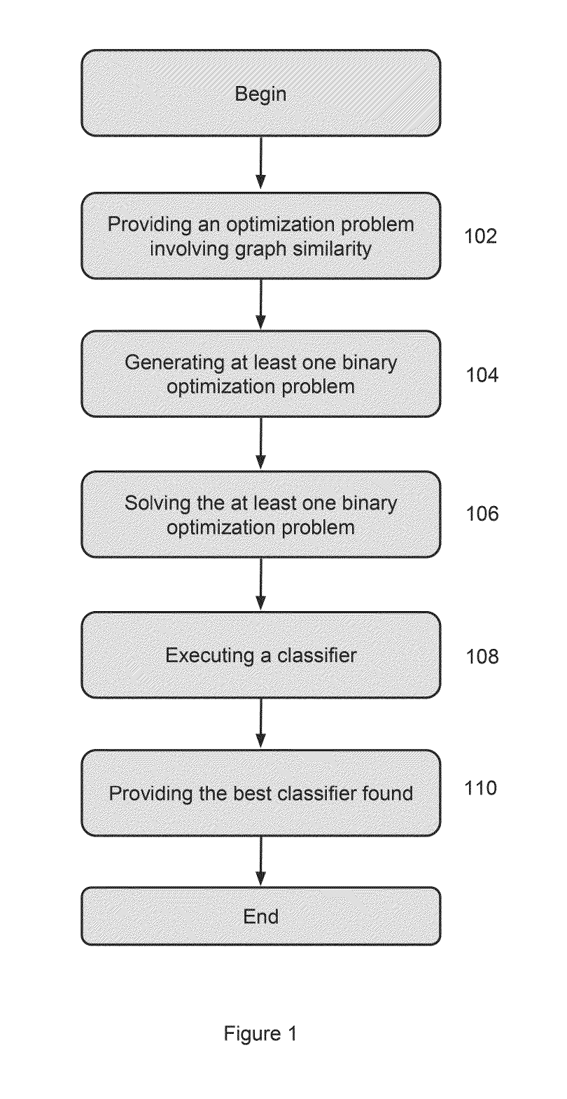

Now referring to FIG. 1, there is shown an embodiment of a method for classifying graphs based on graph similarity using a binary optimizer.

According to processing step 102, an optimization problem involving graph similarity is provided. It will be appreciated that the providing of the optimization problem may be achieved using a script written in a supported language in one embodiment.

it will be appreciated that the optimization problem may consist of an objective function, together with equality and inequality constraints in one embodiment.

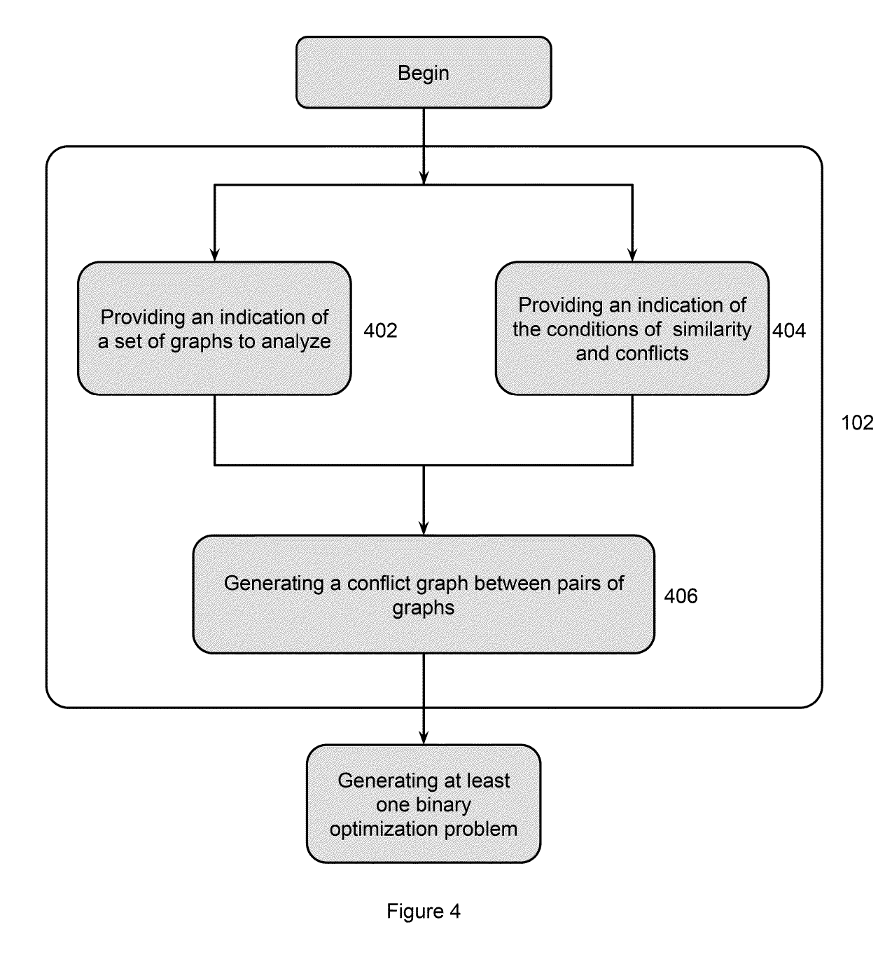

Now referring to FIG. 4, there is shown an embodiment for providing the optimization problem involving graph similarity.

According to processing step 402, an indication of the set of graphs to analyze. In one embodiment, the indication of the set of graphs to analyze comprises a script file provided by the user/programmer/expert system.

For instance, in case of a chemical graph problem, a graph representing a molecule is given, atoms are represented by nodes and bonds between atoms are represented by edges in the graph. Special characteristics of atoms and bonds such as atom type or bond type are encoded in the labels of theft node and edge respectively.

According to processing step 404, an indication of the conditions of similarity and conflicts between two graphs of the set of graphs is provided. In one embodiment, the indication of the conditions of similarity and conflicts between two graphs of the set of graphs comprises a script file provided by the user/programmer.

For instance, in the chemical graph problem, similarities arise if atoms types match and bonds types match. Otherwise, a conflict arises.

While processing steps 402 and 404 have been shown to be performed in parallel, it will be appreciated by the skilled addressee that these processing steps can be performed in sequence.

According to processing step 406, a set of conflict graphs is generated. A module receives a set with pairs of graph representations Sgraphs={(G1,G2),(G1,G3), . . . ,(Gn, Gn−1)}, and the conditions of conflict/similarity for the similarity problem and returns a third graph called “conflict/similarity graph” for each pair in the set Sconflict/similarity graphs={G1,2cs, G1,3cs, . . . , Gn,n−1cs}. The problem of finding the maximum common subgraph between a pair of (or multiple) input graphs is equivalent to finding the maximum independent set in their corresponding conflict/similarity graph.

Referring back to FIG. 1, and according to processing step 104, at least one binary optimization problem representative of the optimization problem is generated.

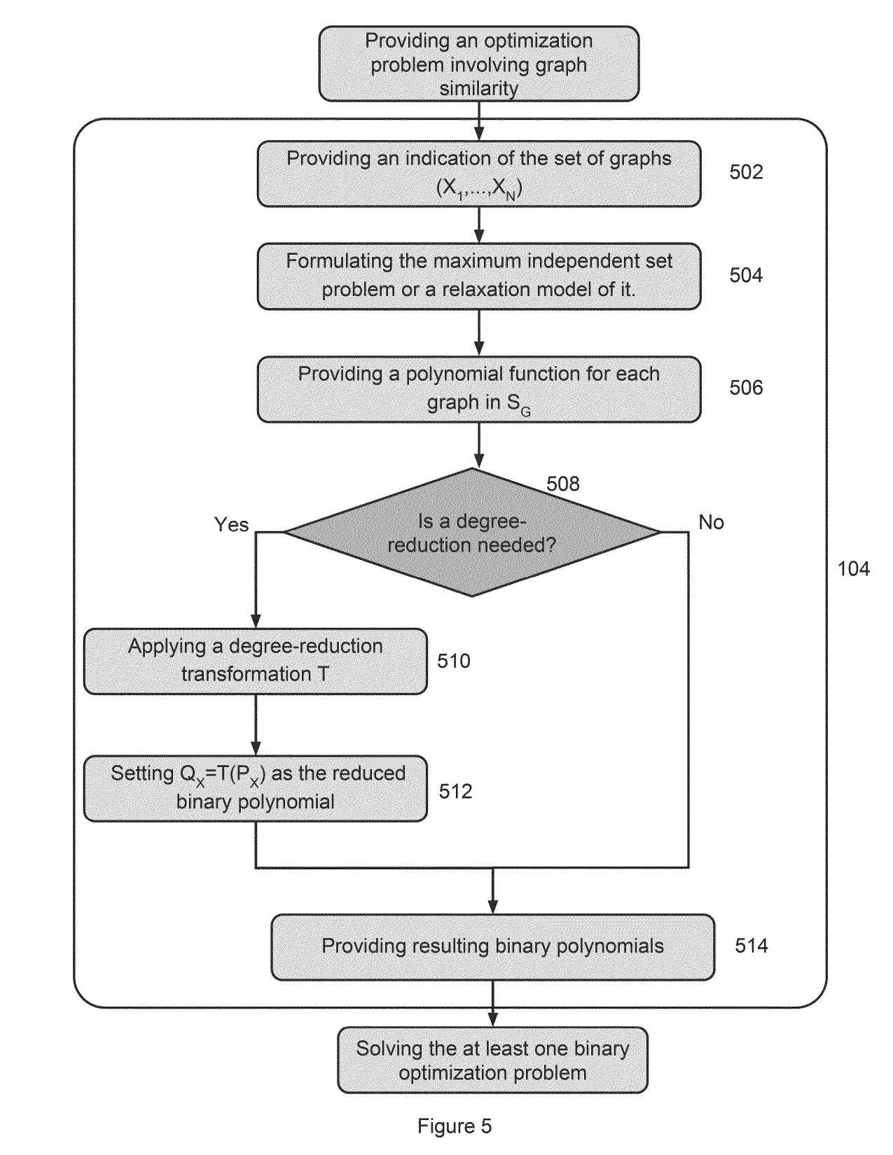

Now referring to FIG. 5, there is shown an embodiment of a method for generating the at least one binary optimization problem representative of the optimization problem involving graph similarity.

It will be appreciated that the purpose of providing the at least one binary optimization problem to the binary optimizer of the analog computer is so that the binary optimization can benefit from any multi-processed, multi-threaded, or simultaneous binary optimization capabilities.

According to processing step 502, an indication of the set of graphs SG={X1, . . . ,XN} is provided. In one embodiment, the indication of the set of graphs SG={X1, . . . ,XN} comprises a script file representative of the set of graphs SG={X1, . . . ,XN}. In one embodiment, the script file representative of the set of graphs SG={X1, . . . ,XN} is provided by the user/programmer.

It will be appreciated that each graph in the set of graphs may be represented with an adjacency matrix, which represents the nodes and edges of the graph. For instance, the set SG={X1, . . . ,XN} may represent the set Sconflict/similarity graphs={G1,2cs, G1,3cs, . . . , Gn,n−1cs}.

Still referring to FIG. 5 and according to processing step 504, the maximum independent set problem or a relaxation model of it is formulated for each conflict graph in SG as an optimization problem with polynomial objective function. One possible relaxation model can be the maximum co-k-Plex problem, where k is the relaxation parameter and it is provided by the user.

An example of an embodiment of this processing step is described hereinbelow. It will be appreciated that a co-k-Plex of n nodes, is a graph where each node is adjacent to at most k−1 other nodes in the graph, where k>0,k ∈ N. The maximum co-k-Plex of a graph X with m nodes, may be found by solving for the maximum solution of the following higher order polynomial function PX of binary variables vᵢ on a binary optimizer;

$$Px ( v ) = {\sum }_{i ∈ \{ 1 , … , m \}} {w}_{i} {v}_{i} - M {\sum }_{{i}_{1} , … , {i}_{k + 1}} {A}_{{i}_{1} … {i}_{k + 1}} {v}_{{i}_{1}} … {v}_{{i}_{k + 1}}$$

wherein vᵢ are the binary variables representing the nodes of the given graph, and wᵢ are the weights associated with each node.

It will be appreciated that A is a (k+1)-dimensional matrix and Aᵢ_{₁}. . . ᵢ_{ₖ₊₁}=1 if nodes vᵢ_{₁} . . . vᵢ_{ₖ₊₁} induce a specific subgraph called a star, and 0 otherwise.

It will be further appreciated that M is a penalty constant and is calculated based on wᵢ.

According to processing step 506, a polynomial function is provided for each graph in SG.

In general, the objective function can be a higher order polynomial function. The plurality of these polynomial functions are collected in a set (P_{X}_{ₗ}, . . . , P_{X}_{_{N}}).

According to processing step 508, a test is performed to find out if a degree reduction on the polynomials is needed. It will be appreciated that the degree reduction on the polynomials may be required depending on the degree of the polynomials compared to the requirements of the solver.

If no degree reduction on the polynomials is needed, no transformation is applied to the polynomials and according to processing step 514 the binary polynomials are provided.

In the case where a degree reduction of the polynomial is required and according to processing step 510, a transformation T is used in order to reduce the degree of each polynomial in the set of polynomials to a degree required by the binary optimizer.

The skilled addressee will appreciate that many techniques may be used to provide the transformation T. For instance, an example of this transformation can be seen in: Endre Boros and Aritanan Gruber (2012), “On Ouadratization of Pseudo-Boolean Functions”, International Symposium on Artificial Intelligence and Mathematics (ISAIM 2012), Fort Lauderdale, Fla., USA, Jan. 9-11, 2012.

Still referring to FIG. 5 and according to processing step 512, a degree-reduction transformation T is applied. It will be appreciated that the plurality of polynomial functions in the set (P_{X}_{₁}, . . . , P_{X}_{_{N}}) are reduced to polynomial functions, (Q_{X}_{₁}, . . . , Q_{X}_{_{N}}) using the degree-reduction transformation T.

According to processing step 514, the at least one binary optimization problem is solved. It will be appreciated that that the solving of the at least one binary optimization problem comprises solving the plurality of binary polynomials representing the at least one binary optimization problem.

Now referring back to FIG. 1, and according to processing step 106, it will be appreciated that the at least one binary optimization problem is solved using the binary optimizer.

More specifically, the binary polynomials are provided to the optimization function. The result of this processing step is an array of sets of solutions of optimization of each polynomial.

It will be appreciated that the solving of the at least one binary optimization problem comprises providing the generated at least one binary optimization problem to a binary optimizer in an analog computer since it will be appreciated that the solving per se of the generated at least one binary optimization problem is performed by the binary optimizer in the analog computer.

The result from the solving of the at least one binary optimization problem is the generated binary solutions.

The generated binary solutions are representative of the maximum common subgraph.

While this has not been disclosed in FIG. 1, it will be appreciated that an indication of the maximum common subgraph may be provided by the digital computer in the case where no classifying of the graphs is required and only the maximum common subgraph is required. In such case the method will stop with the indication of the providing of the maximum common subgraph.

If a classifying of the graphs is required and according to processing step 108, a classifier is executed.

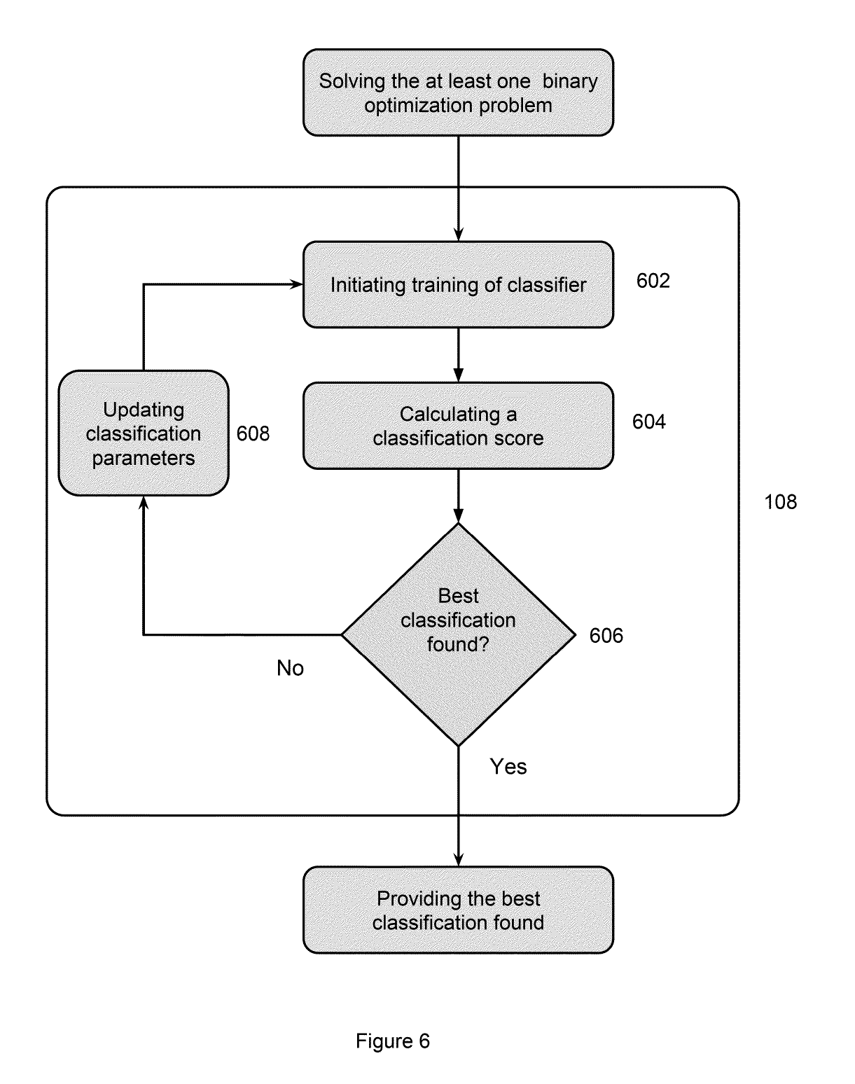

Now referring to FIG. 6, there is shown an embodiment for executing a classifier. It will be appreciated that the purpose of the classifier is to assign each graph to a specific class as defined by the user.

According to processing step 602, the training of the classification method is initiated.

It will be appreciated that the classifier receives, as input, the generated binary solutions to the binary optimization problems of processing step 106. The output provided at processing step 604 is a classification.

More precisely and according to processing step 604, a classification score is calculated for the classification provided at processing step 602.

It will be appreciated that the classification score measures the performance of the classifier. For example and in one embodiment, the classification score may represent the accuracy of the classification. The classification score is used at processing step 606.

More precisely, a test is performed at processing step 606 in order to find out if the classification score computed is the best classification score found. In the case where the classification score is not accepted and according to processing step 608, the classification parameters are updated. Processing steps 602, 604 and 606 are then repeated.

It will be appreciated that the acceptance criteria may be of various types, In one embodiment, the acceptance criteria may include a maximum number of repetitions of processing steps 602, 604 and 608.

In the case where the classification score is accepted at processing step 606, an indication of the best classifier found so far is provided in accordance with processing step 110.

It will be appreciated that the indication of the best classifier may be of various types. For example in one embodiment, a k-nearest neighbour (KNN) classifier can be used, and the indication of the KNN classifier comprises classification parameters such as k, i.e., the number of neighbours to use in the classifier, a weight function and a distance function (where distance function=1-similarity), with its respective parameters.

It will be appreciated that in the case where the optimization problem involves graph similarity in a plurality of graphs, the classifier is executed iteratively with the indication of a maximum common subgraph of at least one pair of graphs to determine a best classifier and the digital computer provides an indication of the best classifier.

It will be appreciated that in an alternative embodiment, there is disclosed a method for solving an optimization problem involving graph similarity in more than one graph using a binary optimizer. In such embodiment, the method comprises obtaining, in a digital computer, an optimization problem involving graph similarity. The method further comprises generating, using the digital computer, at least one binary optimization problem representative of the optimization problem and providing the generated at least one binary optimization problem to a binary optimizer in an analog computer. The method further comprises the digital computer obtaining from a binary optimizer binary solutions generated by solving the at least one binary optimization problem using the binary optimizer and the digital computer providing an indication of a maximum common subgraph in the more than one graph using the generated binary solutions.

Although the above description relates to a specific preferred embodiment as presently contemplated by the inventor, it will be understood that the invention in its broad aspect includes functional equivalents of the elements described herein.

it is to be understood that although the invention has been described above in terms of particular embodiments, the foregoing embodiments are provided as illustrative only, and do not limit or define the scope of the invention. Various other embodiments, including but not limited to the following, are also within the scope of the dams. For example, elements and components described herein may be further divided into additional components or joined together to form fewer components for performing the same functions.

Any of the functions disclosed herein may be implemented using means for performing those functions. Such means include, but are not limited to, any of the components disclosed herein, such as the computer-related components described below.

It will also be appreciated that each computer program within the scope of the dams below may be implemented in any programming language, such as assembly language, machine language, a high-level procedural programming language, or an object-oriented programming language. The programming language may, for example, be a compiled or interpreted programming language.

Each such computer program may be implemented in a computer program product tangibly embodied in a machine-readable storage device for execution by a computer processor. Method steps of the invention may be performed by one or more computer processors executing a program tangibly embodied on a computer-readable medium to perform functions of the invention by operating on input and generating output. Suitable processors include, by way of example, both general and special purpose microprocessors. Generally, the processor receives (reads) instructions and data from a memory (such as a readonly memory and/or a random access memory) and writes (stores) instructions and data to the memory. Storage devices suitable for tangibly embodying computer program instructions and data include, for example, all forms of non-volatile memory, such as semiconductor memory devices, including EPROM, EEPROM, and flash memory devices; magnetic disks such as internal hard disks and removable disks; magneto- optical disks; and CD-ROMs. Any of the foregoing may be supplemented by, or incorporated in, specially-designed ASICs (application-specific integrated circuits) or FPGAs (Field-Programmable Gate Arrays). A computer can generally also receive (read) programs and data from, and write (store) programs and data to, a non-transitory computer-readable storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium.

Any data disclosed herein may be implemented, for example, in one or more data structures tangibly stored on a non-transitory computer-readable medium. Embodiments of the invention may store such data in such data structure(s) and read such data from such data structure(s).

Although the above description relates to a specific preferred embodiment as presently contemplated by the inventor, it will be understood that the invention in its broad aspect includes functional equivalents of the elements described herein.

1. A method for solving an optimization problem involving graph similarity in more than one graph using a binary optimizer, the method comprising:
obtaining, in a digital computer, an optimization problem involving graph similarity;
generating, using the digital computer, at least one binary optimization problem representative of the optimization problem;
providing the generated at least one binary optimization problem to a binary optimizer in an analog computer;
solving the at least one binary optimization problem using the binary optimizer to generate binary solutions;
the digital computer receiving the generated binary solutions from the binary optimizer; and
the digital computer providing an indication of a maximum common subgraph in the more than one graph using the generated binary solutions.

2. The method as claimed in claim 1, wherein the optimization problem involves graph similarity in a plurality of graphs, further comprising iteratively executing in the digital computer a classifier with the indication of a maximum common subgraph of at least one pair of graphs to determine a best classifier and the digital computer providing an indication of the best classifier.

3. The method as claimed in claim 1, wherein the at least one optimization problem is obtained from at least one of a user, a computer, a software package and an agent.

4. The method as claimed in claim 2, wherein the indication of the best classification is provided by the digital computer to at least one of a user, a memory of said digital computer and another computer operatively connected to the digital computer.

5. A method for solving an optimization problem involving graph similarity in more than one graph using a binary optimizer, the method comprising:
obtaining, in a digital computer, an optimization problem involving graph similarity;
generating, using the digital computer, at least one binary optimization problem representative of the optimization problem;
providing the generated at least one binary optimization problem to a binary optimizer in an analog computer;
the digital computer obtaining from a binary optimizer binary solutions generated by solving the at least one binary optimization problem using the binary optimizer; and
the digital computer providing an indication of a maximum common subgraph in the more than one graph using the generated binary solutions.

6. The method as claimed in claim 5, wherein the optimization problem involves graph similarity in two graphs, further comprising executing in the digital computer a classifier with the indication of a maximum common subgraph to determine a best classification and the digital computer providing an indication of the best classification.

7. The method as claimed in claim 1, wherein the at least one binary optimization problem comprises at least one polynomial in binary variables.

8. A digital computer comprising:
a central processing unit;
a display device;
a communication port for connecting the digital computer to a binary optimizer in an analog computer;
a memory unit comprising an application for solving an optimization problem involving graph similarity in more than one graph, the application comprising:
instructions for obtaining, in the digital computer, an optimization problem involving graph similarity;
instructions for generating, using the digital computer, at least one binary optimization problem representative of the optimization problem;
instructions for providing the generated at least one binary optimization problem to a binary optimizer in an analog computer;
instructions for obtaining, via the communication port, binary solutions generated by solving the at least one binary optimization problem using the binary optimizer; and
instructions for providing an indication of a maximum common subgraph in the more than one graph using the generated binary solutions.

9. The digital computer as claimed in claim 8, wherein the optimization problem involves graph similarity in a plurality of graphs, further wherein the application further comprises instructions for iteratively executing a classifier with the indication of a maximum common subgraph of at least one pair of graphs to determine a best classifier and instructions for providing an indication of the best classifier.

10. A non-transitory computer-readable storage medium for storing computer- executable instructions which, when executed, cause a digital computer to perform a method for solving an optimization problem involving graph similarity in more than one graph using a binary optimizer, the method comprising obtaining, in the digital computer, an optimization problem involving graph similarity; generating, using the digital computer, at least one binary optimization problem representative of the optimization problem; providing the generated at least one binary optimization problem to a binary optimizer in an analog computer; the digital computer obtaining from a binary optimizer binary solutions generated by solving the at least one binary optimization problem using the binary optimizer; and the digital computer providing an indication of a maximum common subgraph in the more than one graph using the generated binary solutions.
